(19) United States
(12) Patent Application Publication
(10) Pub. No.: US 2014/0021116 A1
(43) Pub. Date: Jan. 23, 2014

(54) HPLC FRIT FILTER ASSEMBLY

(71) Applicants: Robert A. Ford, Berkeley, CA (US); Vance R. Chin, San Francisco, CA (US); Kevin A. Medlock, Fall River Mills, CA (US); Michael P. Keegan, Berkeley, CA (US)

(72) Inventors: Robert A. Ford, Berkeley, CA (US); Vance R. Chin, San Francisco, CA (US); Kevin A. Medlock, Fall River Mills, CA (US); Michael P. Keegan, Berkeley, CA (US)

(73) Assignee: FH INSTRUMENTS, LLC, Berkeley, CA (US)

(21) Appl. No.: 13/551,608

(22) Filed: Jul. 17, 2012

(51) Int. Cl. B01D 15/10; H05B 6/22

(52) U.S. Cl. 210/198.2; 219/647

(57) ABSTRACT

An apparatus and method for creating a high pressure chromatography frit filter assembly is described. The frit is positioned in bondable contact with a polymer ring and then the frit is subject to inductive or targeted heating to cause the frit material to heat the adjacent polymer ring from the inside out. The polymer to liquefies and flow into and past one or more narrowing locations in the pore passageway extending from the surface of the frit to an infusion depth, which provides previously unachieved secure mechanical engagement and adherence and resistance to pressure blow by (break through) and prevents the flow of contaminants between the edge of the frit and the facing edge of the polymer ring in a high pressure or ultra-high pressure chromatography system, where inlet pressures in the range of pressures up to 18,000 PSI are expected.

### Field of the Invention

High-pressure liquid chromatography (HPLC) is used in analytical and biological chemistry to separate chemical compounds in mixtures for analysis or purification. This disclosure concerns filter assemblies for use in high-pressure small volume systems, e.g., UHPLC (ultrahigh pressure chromatography) systems.

### BACKGROUND OF THE INVENTION

High-pressure liquid chromatography (HPLC) is used in analytical chemistry and biochemistry to separate chemical compounds in mixtures for analysis, purification, and other uses.

Components in a mixture are separated on a column packed with silica-based particles (the stationary phase) by pumping a solvent (the mobile phase) through the column. Depending on the unique affinity of each component (the analyte) between the mobile phase and the stationary phase, each analyte migrates along the column at a different rate and emerges from the column at a different time, thus establishing separation of the mixture. Analytes with higher affinity for the mobile phase migrate faster down the column, whereas those with higher affinity for the stationary phase migrate slower. This migration time (retention time) is unique for each analyte and can be used in its identification. With the appropriate use of a detection method after the column, each analyte can also be quantified for analysis.

Smaller column (stationary phase) particle size can improve chromatographic resolution, but increased solvent delivery pressure is needed. Further reduction of column particle size can allow for higher solvent flow rates, reducing analysis time without sacrificing resolution. This is what gives ultrahigh pressure liquid chromatography its advantage over other liquid chromatography techniques.

The use of smaller column particle sizes requires the use of higher inlet pressures to facilitate column flow. Human blood, the usual component to be analyzed, can contain many large particles which play no role in the column analysis. Further, column particles need to be protected from debris which may be released from the pre-separation column components such as pumps and valves upstream from the separation column. As column particle sizes have been reduced to facilitate the use of smaller sample volumes, the need to reduce the amount of what is known as “dead volume” is also important. The use of smaller and smaller sample sizes (so that less blood can be drawn from a patient) has caused the tubing and other components associated with each separation column to be decreased in size and raising the total pressure needed to drive the sample mixture through the column system. Pressures of 6000 PSI (4.137e+007 newtons/square meter) are common in some recent HPLC systems. A frit prefilter (a porous filter element) is generally used to prevent large particles from entering and contaminating the separation column. Filters need to minimize “dead volume” while having a small porosity (0.1 to 10 μm) throughput. Achieving these goals while maintaining a long separation column lifespan has been difficult to achieve. This difficulty is most evident and acute in diagnostic fields (automated biomedical machines) where frit prefilter failure can result in the need to replace an expensive HPLC column. Currently, prefilters may be replaced daily (approximately every 500 cycles) to protect the HPLC columns from being contaminated before their normal usable life is exhausted. The current normal useable life span of separation columns is about 20,000 cycles or injections. Introduction of better filters could extend this life.

In the manufacture of filters for HPLC systems there are several ways of manufacturing frit elements. Such elements are used in diverse applications ranging from 5000 to 20,000 PSI (3.447e+007 to 1.379e+008 newtons/square meter). These porous filter elements (known as frits) have to be sealed to a filter body assembly to prevent leakage around the filter element (frit) itself.

Currently the three primary methods of sealing a frit element within a filter assembly are: 1) applying pressure on the frit face near its periphery; 2) molding a seal ring around the frit (often using injection molding); or 3) press fitting the frit into a premade plastic annular seal ring. Each of these three methods has disadvantages, which can compromise the filtration function of the frit and its assembly. These failure methods may lead to the contamination of the separation column.

The application of a mechanical clamping force around the edge of the frit face causes the porous openings near the edge to be crushed thereby changing the fit's dead volume, possibly changing pore size within the frit, depending on the clamping mechanism and providing a variable localized contact pressure as the clamping surface comes into contact with a frit surface which is porous having open spaces between walls of the metal base material. The high contact force between the clamping surface and the metal walls is in contrast to the low localized contact force as the clamping surface spans the void between the walls.

Insert molding a sealing ring around the frit can create bonding issues between the frit and the surrounding (injection molded) plastic or polymer. When injection molded plastic/polymer injection pressure is increased (in an attempt to provide better contact and sealing between the surrounding ring and the edge of the frit) the frit can be crushed by the force created by the increased pressure. In addition, the injection molded plastic can flow over the surface of the frit unobstructed and create a solid plastic barrier (or obstruction) to fluid flow through the frit. Such blockage of flow can cause the product of such a process to be rejected as unusable.

Lastly, the press fitting (interference fit) of a frit into a surrounding plastic ring is problematic in that the frit has minimal structural rigidity. A compressive stress at its perimeter will result in a localized deflection and cracking to accommodate the interference fit with the surrounding plastic (polymer) ring. As such, the frit may be easily bypassed along the interference fit contact interface. The goal is to have fluids flow through the frit at high pressures, in actual practice at high pressures the fluids may take a path around the frit rather than through it.

Frits and filters in liquid chromatographic systems (LC) are porous metal products. Their function is to prevent unwanted particles from entering the LC system. These particles may come from the sample, the solvent, or debris generated by LC system itself (i.e., pump or injector). Particles entering the LC system may lead to: A) clogging of capillaries, interference with the chromatography by changing chromatographic parameters, or B) disturbance of the detection function.

The most important characteristic of a frit, besides the diameter and thickness, is porosity. When considering porosity, it is not only the average size of the pore that is of interest, but also the size distribution and the amount of pores available. Take for example, a frit with a 2 μm porosity and a surface of 0.25 inches (0.635 centimeters), the theoretical maximum amount of pores with a 2 μm average diameter would be about 5 million. This frit would give you the highest possible flow achievable. Based on standard bubble point methodology, the same frit having just a few pores would also qualify as a 2 μm frit. Although the porosity may be within specification, it is unlikely that this frit would provide adequate flow.

A typical HPLC system is pictured in FIG. 1. A solvent tank 30 discharges solvent through a solvent tank to pump inlet pipe (line) 32 allowing the pump 34 to pump solvent through a solvent filter 36. The solvent filter 36 prevents debris and unwanted particles from entering the injection valve 38 where samples to be analyzed are introduced. In general the solvent filter 36 is a low-differential pressure filter and will allow a high flow to a large surface area and a large porosity.

Moving parts within the HPLC system can generate debris. Abrasion from the pump piston seals is one of the most common sources. Despite the superior sealing materials available today, small irregularities in the seal itself or the piston, dirt on the piston or an improperly installed seal will result in small particles being removed from seal and being washed downstream towards the injection valve. Regardless of whether the system has a manual or automatic injection system, all injection valves have close tolerances (flat surfaces moving against each other to provide sealing under high-pressure conditions). Improper valve operation can occur as a result of debris interfering with proper sealing of the valve. Alternatively, debris entering the valve can destroy the sealing surfaces, generating additional particles and making it necessary to repair the valve or replace the rotor seal. To prevent this costly damage, a large surface, high porosity inline solvent filter 36 is placed in-line between the pump and the injection valve.

The solvent filters (e.g., 36) have easily replaceable filter discs that can be changed out for a fraction of the cost of repairing a damaged injection valve.

Another source of particles in the system is from the sample itself. Whenever possible the sample should be pre-filtered prior to injection into the system. Once injected the sample travels through capillary tubing (the figure is not to scale) towards the separation column. Particles entering with the sample, or those generated by the injection valve, can easily clog the separation column. Debris passing through capillary inlet tubing will collect in the separation column and can also affect the separation column performance. To prevent these problems it is recommend that a low porosity, small surface area pre-column filter be added between the injection valve and the separation column. Again, the cost to replace the filter element in a pre-column filter, i.e. 42, is minimal in comparison to the cost of a separation column or the time lost to replace plugged capillary tubing.

The separation column element is the one part of the HPLC system that always uses porous frits. A typical column will have two frits, one at the inlet and one at the outlet. The frit on top of the column, or inlet, prevents particles from entering the bed of the column. This frit has a protective function. Any debris that enters the column inlet will be trapped on the inlet filter. Even though the frit can eventually become clogged, the expensive column bed will remain intact.

The inlet frit also aids in the distribution of the solvent/sample over the column. A column with 4.6 mm ID has a surface area that is 330 times (0.25 mm ID) or 1000 times (0.13 mm ID) larger than that of the inlet capillary tubing. The solvent stream has to be distributed evenly over the column surface to give the best results for the separation. The same is true for the outlet frit, where the solvent stream has to be concentrated from 4.6 mm into the small capillary ID without constituent band broadening. The ideal frit for the inlet would have a larger porosity and minimal thickness in comparison to the outlet frit. This would minimize pressure losses and reduce the amount of dead volume. Often, however the same frit size is used on both ends of the column to prevent the user from perceiving any benefit in reversing the hands of the column and switching the flow direction.

The primary function of the outlet frit is to retain the packing material. Here it is important to use a frit with a porosity smaller than the packing material (i.e., a 5 μm packing material would need a 2 μm frit). Care must be taken not to choose too small of a porosity for the outlet frit. All packing material contains some smaller particles and through attrition will also break into smaller particles. If a frit with a very small porosity is chosen, the small particles contained or generated by the packing material will eventually work themselves into the pores and clog the frit, resulting in an increased back pressure. It is generally safe to choose a frit for a column outlet with a porosity rating about half the size of the packing material.

After the sample has left the column it will enter a detector 75. It is desirable to keep the void (dead) volume between the column and the detector cell as low as possible. Small particles of the packing material can penetrate the outlet frit and will then enter the detector. The use of large volume filtering devices between the column outlet and the detector can result in band broadening. At the same time, the detector cell has to be protected from column packing material particles.

Due to pressure differences and the relaxation of the solvent, small gas bubbles can form. The formation of bubbles can be prevented by the use of a back pressure regulator. The porous metal frit in an in line filter can be used as a back pressure regulator, but care must be taken since a clogged frit will continuously increase the back pressure in the detector.

There are a number of things to consider when deciding on what types frits and filters to use in a HPLC system. The choice of material is very critical to the function of the frit. The standard material is 316L stainless steel is suitable for many applications. Porous frits are also available in titanium, Hastelloy and bronze (copper—10% tin), nickel 200, nickel-based alloys Monel, Inconel, titanium, copper, aluminum, and precious metals (for applications that require greater corrosion resistance or biocompatibility). Manufacturing methods for frits depend on: part size, configuration, material and the degree of porosity required. Most porous frits are sintered metal products and are fabricated using one of several sintering methods. One method is that metal powder is pressed in a die at sufficient pressure that the powder particles adhere at their contact points with adequate strength for the formed parts to be handled after ejection from the die. The “green” (unsintered) strength of the part depends upon the metal powder characteristics (composition, particle size, shape, purity, etc.) and the forming pressure. Porous metal parts differ from standard porous metal structural parts in that they are pressed at lower pressures and make a tight mesh of powder to achieve a specified porosity requirement. After forming, the “green” parts are then heated or sintered under controlled atmosphere at a temperature below the melting point of the metal, but still sufficient to bond the particles together. This can markedly increase the parts strength.

Stainless steel, titanium, nickel, nickel alloys, and bronze parts are frequently produced by this method. Advantages include high production rates, good permeability control, and excellent dimensional reproducibility. Porous parts when specified in stainless steel take advantage of the special excellent resistance of stainless steel to heat and corrosion. From a manufacturing standpoint any of the austenitic grades (series 300) of stainless steel may be used, however, from a commercial point of view, only type 316L stainless steel is available in the wide range of particle sizes necessary to make porous powdered metal frit parts conforming to a variety of specifications.

Many frits are also supplied with a press fitted polymer ring. This ring has two functions. First, since a stainless steel frit will not seal well against a stainless fitting, the ring acts as a gasket. Additionally the polymer ring can be configured to fill up a void in the filter support fitting thereby reducing its dead volume. Frits with rings in a wide variety of polymers including PTFE, ETFE, PEEK, and Kel-F are available. The end-user must choose the combination of porous metal and polymer that will perform the best with the intended sample and buffer chemistry.

Frit geometry is another consideration. Frits can be produced with square or chamfered edges, depending on the preference of the end-user. The chamfered edge facilitates assembly in applications where the frit is pressed into another component. Some column builders prefer the straight edged frits because they minimize dead volume. For more demanding applications, a wide variety of specialty frits such as dual density frits with a 5 μm porosity in the center and a 1 μm porosity around the periphery are produced. For other columns a multi-porosity frit that has a coarse support layer mated to a very thin fine filtration layer can provide excellent filtration with minimal pressure drop.

Porous sintered products are a depth-filtration medium with a distribution of pore size and length of passage qualities that are a factor of particles size, shape, and part dimension. The depth-filter not only has more dirt-holding capacity than a screen filter, but also has a higher pressure drop than a screen of equivalent porosity rating.

One example a frit has 0.5 μm pores to protect 3 μm or 5 μm UHPLC separation column packings Frit pore sizes such as 2 μm are well known in the industry. The pore size is chosen according to process operation requirements.

Chamfers

In most cases chamfered edges can be added to porous metal parts. Chamfering permits easier assembly in press-fit operations and strengthens the edge of parts made by pressing which is particularly important in high porosity, coarse grained parts. Both top and bottom edges may be chamfered for parts made by pressing; but in the case of gravity sintered parts, only one edge may be chamfered.

Press Fitting and Sintered Bonding

Machined parts can be attached to porous powder metallurgy parts of similar composition by sinter bonding a press fit assembly in the initial sintering operation or during a secondary heat treatment cycle. Press fitting works well because the porous material can be easily deformed. A good metallurgical bond can be achieved by forming diffusion bonds between the point contacts of the porous material and the hardware components. Assemblies can be made by placing a machined part in the gravity sintering mold or specially designed compaction tooling and then adding the powder prior to sintering. Alternatively, sintered porous parts can be press fit into the hardware, typically with a 1-3% interference fit depending on the part size and material, and then sintered again to form the metallurgical bond.

Welding, Brazing, and Soldering

Porous stainless steel structures can be readily assembled by welding a porous part either to another porous part or to a machined part. Inert arc welding is often used.

Soldering, either hard or soft, and brazing are not recommended with porous metal powder metallurgy parts because the porous matrix metal tends to “wick” (soak up) the flux and solder due to capillary action. However, some special brazing materials and thermal cycles have been developed to “freeze” flow of brazed material in the joint area and to develop a good bond. Overall TIG welding or lower heat input welding methods such as laser welding or electron beam welding are the recommended joining methods to provide adequate mechanical properties and proper sealing.

Epoxy Bonding

Epoxy bonding is another joining method that purportedly can be applied to hold fits. Higher viscosity epoxy works reasonably well (like injection molded material) since such epoxy cannot as easily wick away from the joint area prior to hardening. The development of high temperature and more corrosion resistant epoxies has allowed for longer service life in less severe application environments. The application of epoxies is also an issue, if applied before items are mated the epoxy material will shear/wipe away as it is inserted. If the epoxy is applied to a joint after mating, the epoxy may not propagate (flow) to the bonding area where ideally it should to be located for a best strength bond. In practice liquid epoxy flows through the available space and fills all voids, while high viscosity epoxies do not flow to achieve more than superficial bonding. Attempts at epoxy bonding have not achieved satisfactory process control nor sealing of frits. (Further the resident nature of epoxy material is such that it is nearly impossible to bond with thermoplastic materials such as Delrin®. The inability to precisely control of the chemical reaction used to harden epoxy has been a deterrent in it the practical adoption of the hypothetical/theoretical use of epoxy as a sealing media in frit filter assemblies.

Insert Molding

Porous metal components are good candidates for insert molding with various thermoplastics and engineered resins. The plastic materials have been described as wicking into the edge pores to form an apparently good seal and an apparently mechanically sound bond between the porous component and the plastic injection molded component. Appearances can be deceiving. Testing of insert molded frits has revealed a close topographically matched contact, between the surrounding polymer and the peripheral edge of the pour metal component (frit), without any penetration into the pores. Further, insert molding requires very tight process controls of: overmold temperature, plastic temperature, pressure, hold time, and frit temperature. The temperature of the frit in an injection (or insert) mold is hard to control since it relies on generally conductive heat transfer (surface contact with mold) to both hold and control temperature. To achieve an acceptable frit temperature control using contact heat transfer, frit dimensions have to be specified and manufactured in a narrow thickness tolerance, thereby increasing the manufacturing complexity and cost associated with producing a frit filter assembly. Frit temperature can vary as quality and contact area between the frit surfaces in contact with the heated mold wall vary. A further disadvantage of this thermal process is that as fits have porous open spaces (occupied by a gas such as air during the molding process) the bulk material of the frit tends to be a poor thermal conductor (for the thermal energy generated by the surrounding mold cavity), thereby further compounding the problem of achieving and maintaining a uniform temperature throughout the bulk material of the frit.

Current HPLC systems are increasing in pressure while decreasing the sample size needed. For example, the amount of blood that is drawn at a laboratory to be analyzed needs to be minimized so that the amount of blood needed for processing and analysis in expensive separation columns and with expensive reagents and filters and eventually disposed of is minimized. Therefore separation columns, frits, and capillary tubing connecting the elements having smaller diameters and volumes are being developed which require much higher inlet pressures to achieve the flow rates needed for acceptable process times. Currently the inlet flow pressures to separation columns (e.g., 73) are in the range of 500 to 1500 PSI (3.447e+006 to 1.034e+007 newtons/square meter). In the future it is expected that those columns will decrease in size and the diameter of the feed piping or tubing will decrease in size such that the inlet pressures will be in the range of 5000 to 18000 PSI (3.447e+007 to 1.241e+008 newtons/square meter). The current frit filter technology and filter cartridge assemblies provide reasonable filtration performance at low differential pressures, but when the pressure differential across the frit increases (from a change in process parameters or as a result of clogging of the frit), the inlet fluid pressure seeks its path of least resistance (or weakest link). In many instances (commonly when the frit is clogged and the space between the frit sealing/support ring and the outside edge of the frit is available to be displaced or separated) the path of least resistance will be around the frit through openings created as a result of the effects of the high-pressure inlet fluid causes a bypassing of the filtration. This failure mode is considered a blow by or filter failure. The filter failure results in contaminants from upstream of the frit of being allowed to flow downstream and begin to contaminate the expensive HPLC separation column. There is a need to provide an improved frit filter cartridge used for HPLC prefilters to improve sealing, prolonging life, and generally promote improved efficiency and longevity of HPLC analysis systems.

### SUMMARY OF THE INVENTION

An improved frit filter assembly includes a frit having a first side and a second side opposite said first side and a perimeter side extending around the frit and between the first side and the second side, wherein pore openings in the frit prevent passage of particles larger than a size of the openings in the frit as fluid flows through the frit from the first side of the frit to the second side, wherein the frit has a set of perimeter pore openings on its perimeter side; a frit support ring having a frit facing surface in an interlocking contact with at least one of the first, second, and perimeter sides of the frit, wherein the material of the frit facing surface has migrated into and at least partially through the pore openings in the at least one of the first, second, and perimeter sides of the frit providing mechanical engagement and adhesion between the frit and the frit support ring. wherein the frit and frit support ring are configured to provide a fluid passage from one of the at least one of the first, second, and perimeter sides of the frit to a second of the at least one of the first, second, and perimeter sides of the frit, thereby providing mechanical engagement and adhesion between the frit and the frit support ring, wherein the frit support ring has a frit facing surface surrounding and in an interlocking contact with the perimeter side of the frit, wherein the material of the frit facing surface has migrated into and at least partially through the perimeter pore openings in the perimeter side of the frit providing mechanical engagement and adhesion between the frit and the frit support ring.

An improved frit filter assembly includes a frit having a first side and a second side opposite the first side and a perimeter side extending around the frit between the first side and the second side wherein pore openings in the frit prevent passage of particles larger than a size from the openings in the frit as fluid flows through the frit from the first side to the second side, wherein the frit has a set of perimeter pore openings on its perimeter side. A frit support ring having a frit facing surface surrounds and is in interlocking contact with the perimeter side of the frit. Wherein the material frit facing surface has migrated into and at least partially through the perimeter pore openings all around the perimeter side of the frit providing mechanical engagement and adhesion between the frit and the support ring. The mechanical engagement and adhesion between the frit and support ring is characterized by preventing the passing of fluid from the first side of the frit to the second side of the frit between the perimeter side of the frit and the frit facing surface of the frit support ring. Mechanical engagement and adhesion includes migration of the frit support ring material from the frit facing surface into and through perimeter pore opening to a distance towards the center of the frit equaling two or more frit pore sizes from the perimeter side of the frit; where the frit is made from a material chosen from the list comprising steel and its alloys, stainless steel, aluminum, titanium, any inductively heatable material and glass; where two or more frits are stacked one on top of the other and all perimeter sides of the two or more fits are contained within and facing the frit facing surface of the frit support ring. Where the perimeter side around the frit includes an edge chamfer; where the frit support ring is made of a polymer; where the polymer is polyoxymethylene; where the polyoxymethylene is infused into the pores along an outer diameter of the frit adjacent the inner diameter of the surrounding support ring; where the infusion of the polyoxymethylene into the outer perimeter is beyond the outermost pore neck; where the infusion of the polyoxymethylene into the outer perimeter is beyond the outermost pore neck and a second outermost pore neck from the outermost pore neck in the pore passages.

A method of making a frit assembly comprising the steps of placing a frit surface of a frit having a selected porosity in contact with a surface of a polymer frit support ring; heating the frit for a predetermined time to provide infusion of the polymer material into the pores at the surface of the frit through at least one or three pore neck locations of the pore passages from the surface of the frit.

A method of making a frit assembly comprises the steps of placing a frit having a selected porosity within a surrounding polymer ring such that a perimeter outer surface of the frit is in contact with an inner perimeter surface of the polymer ring and heating the frit for a predetermined time; where the step of heating the frit is done by induction heating; where the induction heating is done by using a wire having a loop located near the frit, the loop creating a loop having a central axis approximately parallel to the one or more fits being heated and in close proximity thereto; where the induction heating coil is energized with a 400 KHz to 2 Mhz frequency range for approximately 30 to 8 seconds at approximately 2000 W (actual operating parameters depending on the amount of material and its size as understood by persons of ordinary skill in the art); where the step of heating the frit is done by RF heating; where the step of heating is done by infrared heating; wherein the step of heating is done from both ends using a laser light; wherein the step of heating the frit is done from both ends using contact heating; wherein an anvil (made of a non-inductively (non-metallic) heatable material with a higher melting point than the polymer ring that it supports) supports the frit and surrounding polymer ring during heating; wherein a lower anvil supports the frit and surrounding ring and an upper anvil covers the frit and surrounding polymer ring during heating; wherein the surfaces facing the frit are polished; wherein the anvils are cooled by using cooling air or by using a water jacket; wherein a seal created between the frit and surrounding polymer ring is checked using a water flow through the frit and surrounding ring assembly; where a seal created between surrounding polymer ring is checked using an air flow through the frit and surrounding ring assembly; where the step of placing frit within a surrounding polymer ring is done on a support anvil; wherein the step of placing the frit within the surrounding polymer ring includes placing a cover anvil over the frit and surrounding polymer ring's wherein the surfaces of the anvils facing the frit are polished.

A frit assembly comprising, a frit having a first side and the second side opposite the first side and a perimeter side extending around the frit and between the first side and the second side wherein pore openings in the frit prevent passage of particles larger than a size of the openings in the frit as fluid flows through the frit from the first side to second side; where the frit has a set of perimeter pore openings on its perimeter side, the frit support ring has a frit facing surface surrounding and in interlocking contact with the perimeter side of the frit, where the material frit facing surface has migrated into and at least partially through the perimeter pore openings all around the perimeter side of the frit providing mechanical engagement and adhesion between the frit and the frit support ring where the mechanical engagement and adhesion between the frit and frit support ring is characterized by cutting the assembly in half along the central axis of the flow passage through the frit and determining that each half of the frit remains adhered to its frit support ring on its perimeter side. Which is in contrast to a frit filter assembly where the mechanical engagement and adhesion between the frit and the frits support ring fails, causing the frit and its perimeter side frit support ring to separate upon cutting the assembly in half.

### BRIEF DESCRIPTION OF THE DRAWINGS

FIG. 1 shows a schematic diagram of a prior art of high-pressure liquid chromatography system.

FIGS. 2, 2A, and 2B show prior art cross-sectional schematic configurations of frit filter assemblies as used in the prior art HPLC systems, such the one shown in FIG. 1.

FIG. 3 shows a prior art single frit pre-assembly cross-section of a single frit disk prior to being joined to a surrounding polymer ring.

FIG. 4 shows a prior art dual frit pre-assembly cross-section prior to being joined to a surrounding polymer ring.

FIG. 5 shows pre-assembly cross-section showing three fits discs prior to being joined to a surrounding polymer ring.

FIG. 6 shows a cross-sectional view of another embodiment of a frit assembly configured within a polymer ring assembled from the pieces shown in FIG. 4.

FIG. 6A shows a close-up of the interface between the frits and surrounding polymer ring of FIG. 6.

FIG. 7 shows a cross-sectional view of chamfered frits within a polymer ring.

FIG. 7A shows a close-up of the interface between the prior art chamfered frits and surrounding polymer ring as shown in FIG. 7.

FIG. 8 shows an idealized schematic view of a pre-assembled configuration of three chamfered frits prior to their assembly within a surrounding polymer ring.

FIG. 9 shows a cross-section of the assembly of an induction heating apparatus providing a mechanical bond and adhesion between the pieces shown in FIG. 8.

FIG. 10 shows a cross-section of the completed mechanically bonded and interlaced fits of FIG. 8 within a surrounding polymer ring as achieved by the process and apparatus shown in FIG. 9.

FIG. 11 shows a top view of a frit with in the polymer ring of FIG. 10 showing or illustrating a heat affected zone or heat melt zone of the polymer ring providing mechanical engagement and adhesion between the fits in the center and the surrounding ring.

FIG. 12 shows a close-up cross-section of the three frits of FIGS. 8, 9, 10, and 11 showing in detail the heat affected (melt) zone of the polymer ring and mechanical engagement of the polymer ring with three frits.

FIG. 13 shows a close-up of a part of FIG. 12 highlighting the heat affected zone and the interrelationship between the surrounding polymer ring and the three fits which have been mechanically engaged by the apparatus and process shown in FIG. 9.

FIG. 14 shows a top view of an alternate embodiment of a polymer ring surrounding a stack of two fits which have been mechanically engaged and adhered to the surrounding ring in a process apparatus such as shown in FIG. 9.

FIG. 15 shows a cross-sectional view of the frit filter assembly of FIG. 14 taken at line 15-15.

FIG. 16 shows a cross-sectional close-up view of the infiltration of the surrounding plastic/polymer ring material into the perimeter side (edge) of the frit to an infusion depth due to the use of the apparatus and process such as shown in FIG. 9.

FIG. 17 shows another view of the cross-section of a frit and surrounding polymer ring as seen in the FIGS. 14, 15, and 16 showing the infusion of the polymer material to a given (process adjustable and controlled) depth relative to the distance from the centerline axis of the frit to the infusion distance.

FIG. 18 shows a close-up side view of the induction heating apparatus FIG. 9 showing the external view.

FIG. 19 shows a top cross-sectional view of FIG. 18 taken at 19-19 showing the shape induction coil surrounding the frit and polymer ring inside of which it is engagingly infused and mechanically bonded according to the process of the apparatus of FIG. 9 and its method.

FIG. 20 shows an arrangement of two chamfered edge frits prior to assembly into a polymer ring.

FIG. 21 shows an alternate embodiment of the apparatus of FIG. 9 showing the processing of a two frit stack inside of a polymer sealing ring, where the polymer sealing ring and frits are facing anvils which are cooling it.

FIG. 22 shows an arrangement for testing the satisfactory processing of a frit assembly for mechanical engagement and adhesion as described in the processes performed by the apparatus of FIG. 9 and FIGS. 18 and 19.

### DETAILED DESCRIPTION

A HPLC system includes a solvent tank 30 having solvent flowing through a pipe 32 to a pump 34 which in turn pressurizes and drives solvent through a solvent filter 36 to an injection valve 38 where sample materials or other products to be analyzed are injected. The material is then driven through the piping (tubing) 40 to a stainless steel frit holder or prefilter assembly 42 containing a frit holder inlet fitting assembly 44, a stainless steel filter assembly 54, and a frit holder outlet fitting assembly 60. The filtered fluid once having passed through the frit filter in the prefilter assembly 42 passes through the piping 71 to analysis column 73, where as described above, the constituents move according to their analyte to a detector 75. A recorder/personal computer (PC) 77 receives analysis signals from the detector and the fluid coming out of the separation column is passed into a waste reservoir 79.

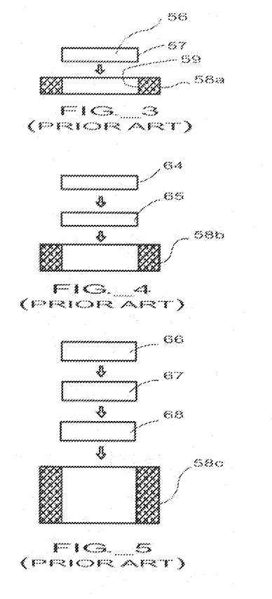

Alternate arrangements of prior art prefilter assemblies 42 are shown in FIGS. 2, 2A, and 2B. In FIG. 2 is a stainless steel one-piece frit 56 is shown with its surrounding polymer/plastic ring 58B clamped between a frit holder inlet fitting assembly 44 and a frit holder outlet fitting assembly 60 as the sample and solvent is pressurized and flows into the frit filter assembly through frit holder inlet line 46 and is discharged after having passed the location of the frit holder assembly through the filter outlet line 62. The sealing in this instance is done by a linear clamping of the frit and surrounding plastic ring between the frit holder inlet fitting assembly 44 and the frit holder outlet fitting assembly 60. In this instance and configuration the tolerances of the pieces must be very precise to prevent leakage around the frit and ring assembly.

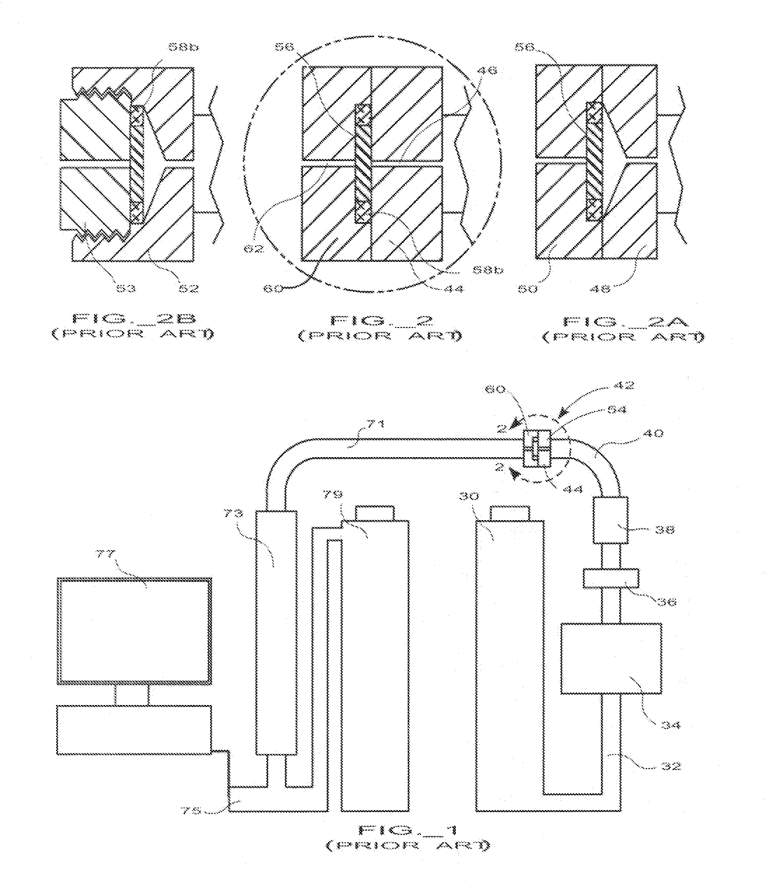

Another configuration of a prior art frit filter assembly such as prefilter assembly 42 (of FIG. 1) is shown in FIG. 2A wherein a frit holder clamped inlet fitting 48 having an inlet funnel or beveled manifold and outlet fitting 50 is directly clamped on the stainless steel frit filter assembly (56 & 58b—see FIG. 2). The plastic ring surrounding the frit is a little bit thicker than the frit depth pocket into which the frit and ring assembly fit into frit holder clamped outlet fitting 50, such that when the pieces are joined the outer parts of the bevel of frit holder clamped inlet fitting 48 tightly clamp and press on the perimeter edges of the plastic ring.

FIG. 2B shows an alternate arrangement for the clamping of a frit filter assembly such as prefilter assembly 42 (of FIG. 1) wherein the frit holder inlet fitting 52 has a female thread and the frit holder outlet fitting has a male thread 53 which engage and can be rotated relative to one another to exert a clamping force on the frit and surrounding plastic ring assembly. Each of these described prior art frit and surrounding plastic ring assemblies are deficient in that at high-pressure there may be a blow by or break through of the inlet fluid. Such errors can lead to a flow of unfiltered liquid from frit holder inlet line 46 to the filter outlet line 62 (FIG. 2).

FIGS. 3, 4, and 5 show prior art pre-assembly arrangements of single frit, double frit (two stacked frits) and the triple frit (three stacked frits) configurations within surrounding plastic rings as is known in the prior art. In the configuration shown, the frits 56, 64, 65, 66, 67, 68 are square cornered frits and each of them have an outer surface perimeter surface although only the outer surface 57 of the one piece frit 56 in FIG. 3 is specifically identified. This outer perimeter surface engages with or interferes with the inner facing surface (or inside facing surface) 59 of the polymer (Delrin®) ring surrounding the frit. When the frit thicknesses as pictured in FIGS. 3, 4, and 5 are of a single dimension then the surrounding polymer rings are of different heights as identified in FIGS. 3, 4, and 5 as rings 58a, 58b, and 58c (the drawing is not scalable) to accommodate the different total thicknesses of the fits to which the surrounding polymer ring will be bonded.

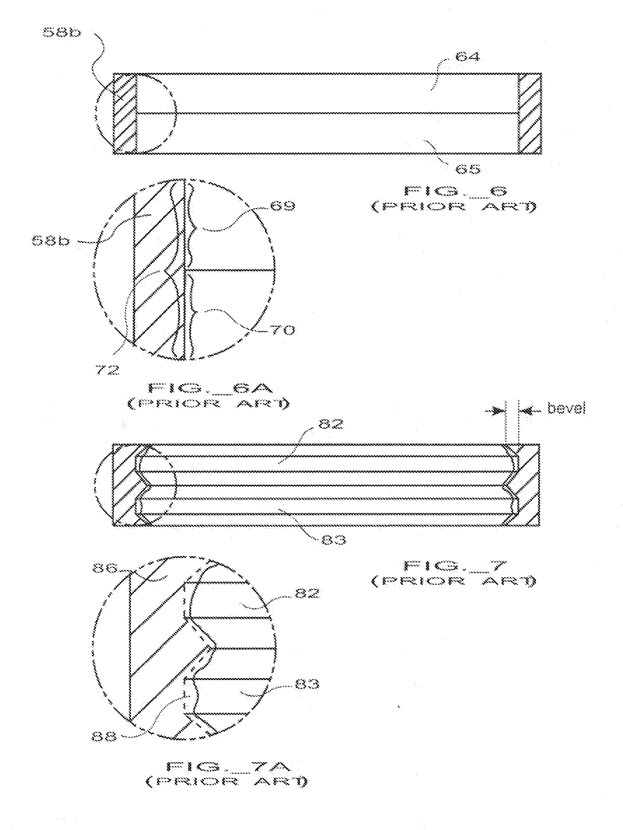

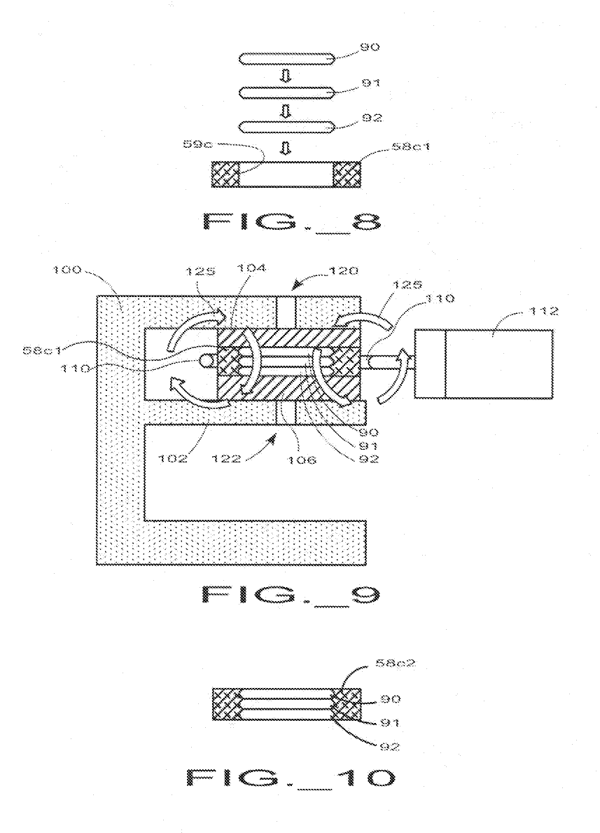

FIGS. 6 and 6A show a prior art close-up cross-section of the assembled square cornered frits as pictured in FIG. 4. (The drawing is not to scale.) The outside perimeter (edge) surface 69 of the upper frit 64 and outside perimeter surface 70 of the lower frit 65 are shown in interfering/close contact with the inside edge surface 72 of the surrounding polymer ring 58b. In current configurations when the upper frit 64 and lower frit 65 are interferingly fit within the polymer (Delrin®) ring 58b, there is a contact force between the outside perimeter surface or edge of the frits 64 and 65 exerted at the outside perimeter surfaces 69, 70 of the respective frits on the inside surface 72 of the polymer ring 58b. As pressure mounts on one side of the filter frit cartridge, the inlet pressure will seek it's path of least resistance and cause the unbonded surfaces of the mechanically interfering pieces to separate and allow fluid to flow through the space between the outside edge surfaces of the frits 64, 65 (outside edges being designated as 69, 70) and the inside surfaces 72 of the polymer ring 58b.

FIG. 7 shows a cross-sectional view of a chamfer edged two stacked frit according to the prior art which has been insert molded (injection molded). An upper frit 82 and a lower frit 83 are engaged within an injection molded polymer ring 86. The injection molding frit material will fill all of the surface cavities of the edge of the frit as is illustrated by the apparent overlap between the dashed line and the solid line as shown in FIG. 7A reference line number 88 is pointing to the superficial contour contact achieved as a result of the injection molding process filling every nook and cranny on the outside edge surface of the frit (without confusion or inward migration). The effective external perimeter surface or outer edge of the frits 82, 83, are filled just as a lump of clay when dropped on a sidewalk would fill all of the un-even nooks and crannies facing the upper surface (and the lump of clay) while not being able to engage with the uneven surface any more than by the close matching of the injection molding plastic with the un-even surface of the outer edge of the frits 82, 83. While it might appear that the outer plastic surface has infused into the edge of pores of the frit, in fact, the nature of the injection molding process is such that a “cold head” causes the leading edge of the injection molded material to be “cold” and therefore establishes a self-adhering surface tension (and a cooled leading edge which has already begun solidifying) which prevents the injection molded material which has been pressurized and infused from an outside source into a cold mold, from remaining liquid and infusing into a cold frit.

The absence of infusion of the injection molded material into the base material at the edge of the frit, or even into the first row of the pore opening to the inside of the frit material from the outside through the outermost pore or even the second outermost pore is apparent when the a completed frit assembly from an injection molded process is cut in half and the frits do not adhere to the surrounding plastic ring, but rather fall out because they (while being mechanically engaged to all surface imperfections of the outside perimeter edge of the frits 82), have no tensile bond or engagement with the edge of the surrounding injection molded polymer ring 86 other than a close mechanical (topographic) proximity (matching). Thus in practice when the insert molded frit cartridge as shown in FIGS. 7 and 7A is put into use, it exhibits pressure breakthrough characteristics similar to those exhibited by the interference fit frit cartridge assembly shown in FIGS. 6 and 6A. While there may be some improvement in breakthrough pressure rating (failure pressure) for the insert molded beveled edge frit assembly cartridge as compared to the simple interference fit assembly, as previously described, such improvement is slight and relatively unmeaningful in terms of extending the life of the liquid chromatography separation column, which is the goal of the use of a frit assembly or frit cartridge in a frit filter assembly as used in an HPLC system.

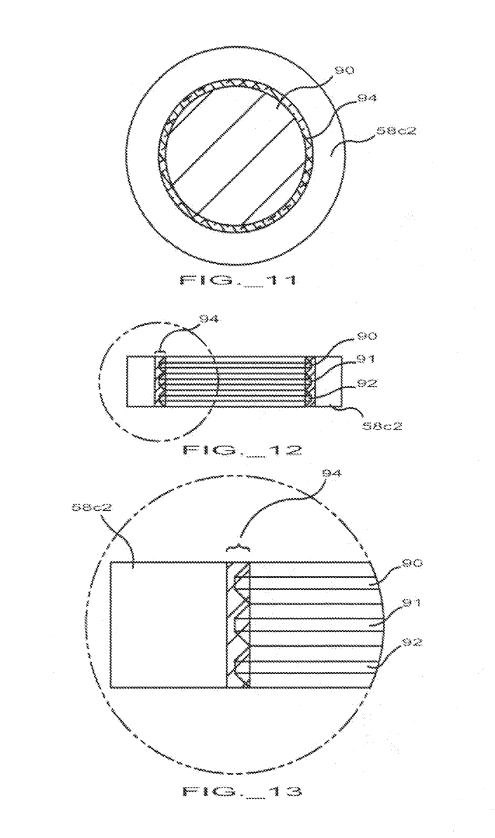

FIG. 8 shows a pre-assembled configuration of a frit filter and surrounding ring cartridge assembly having three chamfered edge fits (or frit elements) 90, 91, 92 positioned for assembly and insertion into a surrounding polymer (Delrin®) ring 58c1. The outer perimeter edges of the fits 90, 91, 92, are sized to provide several thousands of an inch (0.0254 mm) interference fit inside of the inside surface 59c of the surrounding ring 58c1. The frits are put in position and then placed in a processing configuration of a fixture as shown in FIG. 9.

FIG. 9 shows a sealing fixture base 100 preventing a sealing anvil upper 104 from moving upwards as a sealing anvil lower 106 is forced upwards by a sealing fixture adjustable arm lower 102 (the mechanism and joints allowing relative motion are not shown in this static schematic diagram). The sealing anvil upper 104 and sealing anvil lower 106 clamp or hold the three chamfer cornered fits, 90, 91, 92 in position inside of the polymer (Delrin®) surrounding ring 58c1.

As the pieces are positioned and clamped, an induction coil 110 surrounds and is approximately centered on the ring frit and ring cartridge assembly powered by an induction coil head 112. As the induction coil is energized, a magnetic field represented by (illustrated imaginary) magnetic fields lines 125 is created to induce a current and create a temperature rise in the metal of the frits. As the metal temperature increases, the frits and the pores therein tend to slightly expand and since the frits are in contact with the surrounding plastic (Delrin®) ring 58c1 the polymer/plastic material having a higher coefficient of thermal expansion and being heated from the inside, with the outside still cool, creates an expansion force inwards towards the outside edge of the perimeter surface of the fits 90, 91, 92.

After a short period of time (a range of 0.5 to 20 second, for example), established by empirical experimentation(different heating times and current flow combinations should be evaluated such as one second at 100 W, 10 seconds at 10 wants to see which provides an inflow (or migration or extension) of one or two or three (or neck) passages into the surface of the frit). Different frequencies (approximately 400 kHz to 1 MHz) can also be tried to see how optimal results can be reached, limited only by the accessibility of induction heating power sources with a particular frequency. A small amount of the surrounding polymer material, preferably Delrin® (also generically known as polyoxymethylene) partially melts and as a result of its contact with the heated frit is infused and flows into the pores at the outer edge perimeter surface of the metal frits 90, 91, 92. Because the metal heating is from the inside out, the amount of infusion and mechanical engagement can be controlled by the amount of heating (thermal energy) applied.

Process variation control is related to the volume in the mass of the fri—the success of changes in process parameters can best be determined by destructive testing of a process to frit to determine whether the polymer material has infused into surface pores to a depth passing one or two pore passage neck constraints to become satisfactorily trapped and bonded to the pores by a microscopic mechanical interference and tensile member. (The tensile member is the small cross-section of the polymer material which is extends through and into the pore neck's and is prevented from pulling out because of the material beyond the pore necks which has expanded to a larger size than the pore neck. Use of super high temperature tends to boil the polymer—lower temperatures require longer heating times which tend to heat the polymer support material as well. A process designer this fixture would want to use the highest energy input to achieve a high temperature for a short time to maximize reliability but avoid excessive flow if the heating time becomes too long. Frequency, power, and heating times are variables that can be adjusted in the process. While generally, the higher the frequency—the shallower the heating depth—the size of the metal fits heated are so small (<7 mm in diameter) that temperature gradients across the dimension of the frit would not be measured in any practical way.

The infusion of the polymer (Delrin®) material through the outside set of the pores goes through one, two, or several narrowing passages (necks, bottlenecks, or throats) and creates a continuous material flow (hourglass type, throat shaped tensile elements) of the partially melted plastic which has flowed in towards the center of the frit or frits from the outside surface of the frit or frits. Once heating is ended, the polymer material which has been experiencing a temperature gradient by being heated from the inside out into just slightly above its melting temperature at its inner most surface starts to cool and solidify. The absence of heating creates a cooling of the frits and polymer material. The cooling process can further progress as the heating is instantaneously eliminated by the elimination of current flow through the coil creating the induced magnetic field in the surrounding coil 110. While passive cooling provides a satisfactorily frit and surrounding ring cartridge assembly results and performance, active cooling instituted by providing moving air into cooling inlet hole upper 120 and cooling inlet hole lower 122, will accelerate the cooling timing and reduce the amount of waiting time between heating processes of the same heating assembly.

The method of making a frit assembly includes heating the frit for a predetermined time, each is a time sufficient to raise the temperature of the frit surface in contact with the frit support ring surface to melt the frit support ring material to cause it to infuse into pores and through one, two, or more pore throats as the polymer infuses in to the pores in the frit, but is not a time so long that the melting the of frit support ring material and its infusion into pores in said frit material deforms the polymer ring so much that it prevents sealing of the frit filter assembly to its inlet fluid flow source. Or that the infusion flow has substantially blocked pores in the frit to prevent fluid flow from its inlet side (surface) to its outlet side (surface). When there is too much polymer material flow because of prolonged heating, voids are created in the bulk material of the frit support ring, which prevent tight clamping and sealing of the polymer frit filter support material. Depending on the character of the voids in the bulk polymer material and the clamping configuration of the frit filter assembly to an inlet fluid fixture the seal, if any, between the frit support ring may not be able to be formed, or may initially be formed and then will cause filter break through at pressures selected pressure ratings such as: 1500, 5000, 10000, 15000, and 18000 psi. The breakthrough in the bulk polymer material would provide an indication of a deficiently refined heating time, particularly that the heating time is too long as voids in the polymer material which create breakthrough are created.

While FIG. 9 provides one configuration for arranging the frit and frit support ring to establish a polymer support ring infusion (a mechanical engagement and adhesion) bond between the perimeter of the frit and the frit support ring, other configurations to bond a support ring to a frit with an interface between the support ring and frit on at least one or more of a top, bottom, and perimeter (first, second, and perimeter) sides of complimentary surface of the frit and frit support ring are possible.

A fixture for an holding such other configurations would hold the frit and frit support ring in a fixed position with at least a minimal contact force between the two. The surrounding fixture elements would be configured to prevent motion of the frit and frit support ring and to prevent migration of the polymer (during the time of heating of the frit to cause infusion/migration of the adjacent polymer) to locations which would prevent flow through the bonded filter frit assembly (keep a flow path through the frit filter assembly unblocked by the infused (during induction heating) or melted polymer. In the instance when a small fluid inlet passage is provided in the frit support ring, use of a rod to prevent closing of the inlet passage during the induction heating may be part of the holding fixture.

In one configuration the fixture, made of non-inductively heatable materials around which a wire loop(s) most efficiently positioned to be approximately centered on the frit for induction heating of the frit made of an inductively heatable material (this arrangement), provides a temporary capsule whose internal configuration, closely matches the desired outside configuration of the final bonded (polymer infused into an edge or surface of the frit) frit filter assembly which may include clamping elements to hold the frit and frit support ring in a near final configuration. While such internal configuration may initially act a process stabilizing barrier, which initially prevents an polymer which has been overheated from flowing beyond inside surface configuration of the capsule (thereby preventing a slightly overheated polymer from deforming so much that it is deemed unusable (defective) because polymer flow from overheating has created defects which cause the frit filter assembly from such a process to fail to meet its flow, filtration, and/or sealing specifications).

A successful frit filter assembly will provide an acceptable flow (through a fluid passage or one or more pores providing fluid passages) through its frit(s) while preventing flow around the seal between the frit support ring and one or more surface of the frit by having the polymer infused into the pores of the surface and to a depth from the surface established by one or two pore necks, as it infuses into the pore passages. The frit support ring could be of any geometry and shape having one or more flow passages therethrough which are sealed to one or more frit surfaces to prevent leakage and filter breakthrough between the frit and the support ring to pressures as high as 10,000 to 18,000 psi, while having a configuration which allows a portion of the frit support ring not in contact with the frit in use to have a tight seal (preventing flow there through to pressures higher than the maximum breakthrough pressure of the frit to frit support ring seal) to a frit filter assembly holding and sealing fixture.

While circular and elliptical frit and frit support ring shapes are described herein, any frit and/or frit support ring geometry such as rectangular or multifaceted and three dimensional can be used as long as a seal to an external holding and sealing fixture can be established. Frit filter assemblies as described herein could be used in any location where high differential pressure small pore opening size filtering is required. In a high pressure liquid chromatography system it could be an independent pre filter or a pre and/or post chromatography separation column frit filter assembly which is integrated into one or both ends of a separation column cartridge using a particulate packing such as silica (thereby preventing the particulate packing material from leaving the column) during forward process flow and reverse back flow cycles of such separation columns, as is well understood in the art.

FIG. 10 shows a cross sectional macro view of a completed frit and surrounding ring cartridge that has been processed by the processing assembly of FIG. 9. In FIG. 10 the simple square edged configuration of the surrounding ring as can be seen in FIG. 8, where the surrounding ring 58c1 has now transformed into a thoroughly mechanically engaged with and inside surface adhered to the outside surface of the frits 90, 91, 92 Bonnie infusion of polymer material into the outside surface pores and to a depth passing one or two pore necks as it flows into the pore passages, in the form of frit surrounding ring 58c2.

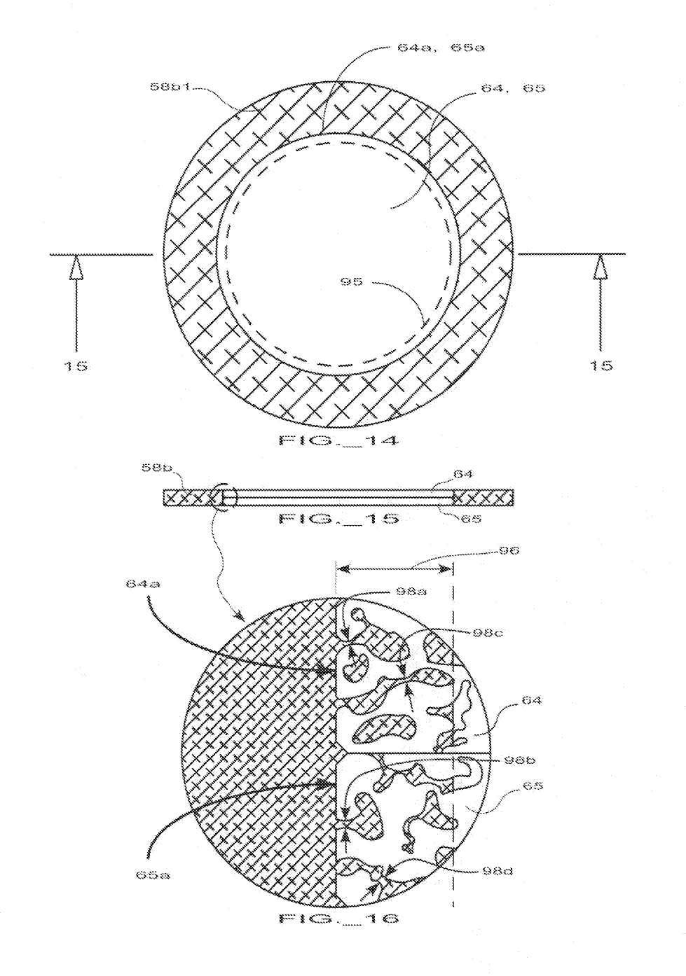

FIG. 11 is a schematic top view of the frit as shown in FIG. 10 wherein the surrounding polymer (Delrin®) ring 58c2 is mechanically engaged and adhered to the fits 90, 91, 92 although only the top frit 90, can be seen in FIG. 11. A schematically presented cross-sectional heat affected, or heated melting zone 94 shows the infusion of plastic/polymer/thermoplastic/Delrin® material from the outside (periphery) ring towards the center of the frit 90 (through its pore passages).

FIG. 12 shows a schematic cross-sectional view of the three stacked frits of FIG. 10 whose heat affected/melting zone or melt affected zone 94 is shown at the outer peripheral surface edge of the frits 90, 91, 92, where they come into contact with inside surface of the surrounding ring 58c2 which has now been transformed from a straight squared cornered surface to a multi-contoured surface as it has infused into and through pores at the edge of the frit. FIG. 12 shows an approximate configuration of the heat affected zone and plastic material fusion and is for general illustrative purposes only.

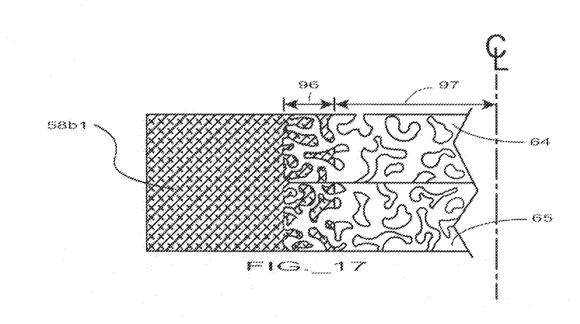

FIG. 13 shows a close-up view of the heat melt affected 94 as is seen in FIG. 12. While from this illustration it appears that the engagement of the plastic surrounding ring material is similar to that shown in the prior art for injection molding has seen in FIGS. 7 and 7A, the following discussion will highlight that the sealing and engagement and adhesion (infusing into and through pore passages and past pore necks) created by the process described herein which supersedes and exceeds by multiple times the pressures that can be resisted across—prior art filter frit and surrounding ring cartridges in use.

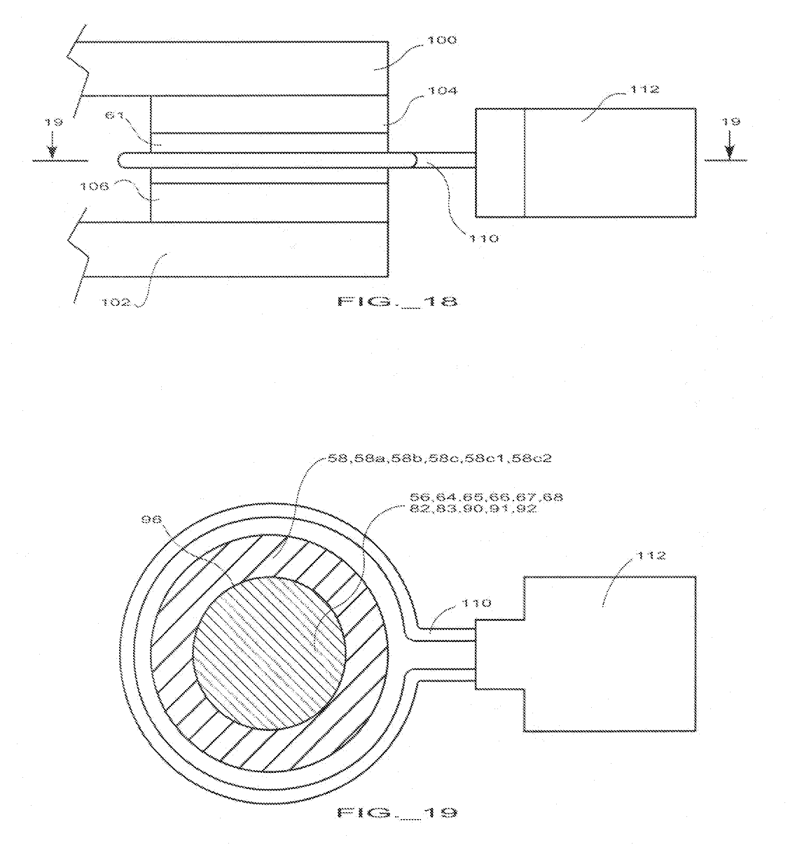

FIG. 14 shows a top view of an another embodiment of a frit filter arrangement, whose assembly and manufacture could for example be started by the pre-assembled arrangement shown in FIG. 4 with square cornered fits and a square inside cornered surrounding plastic/polymer ring. However, that is where the similarity ends. The dashed line 95 depicts the inner limit of plastic/polymer infusion. Mechanical engagement and adhesion of the surrounding polymer ring 58b having the pre-processing square edged configuration (as can be seen in FIG. 4) having been processed and now having a post processing configuration 58b1. The space between the dashed line 95 and the perimeter outer edge surfaces 64a, 65a (pore infusion zone) of the frits 64, 65 having been processed is considered the ‘melt affected zone’ which radially covers an infusion distance 96 as can be seen in FIG. 16, where the infusion of the liquefied polymer material from the surrounding polymer ring 58b has transformed through processing to surrounding polymer ring post processing configuration 58b1. It has passed through pore necks (throats) 98a, 98b, 98c, 98d where the first two necks (also can be identified as a distance equaling two or more frit pore sizes) closest to the outside surface are identified as 98a and 98b and for the necks inside the outer necks (throats) 98a, 98b are identified by secondary or tertiary pore neck or throats 98c, 98d to where there is a generally uniform infusion distance 96 from the outer edge surfaces 64a, 65a of the of the frits 64, 65.

FIG. 17 shows an alternate cross-sectional illustration of the configuration of the frit ring cartridge of FIGS. 14, 15, and 16 showing the infusion distance 96 to a given (controlled) predetermined infusion depth from the outer perimeter peripheral surface of the fits 64, 65 while still maintaining an available active process fluid flow volume at a distance 97 from the inside limit for the infusion, to the centerline of the frit.

FIG. 18 shows an outside side view of the processing assembly configuration of FIG. 9, wherein the sealing fixture base 100 opposes the sealing fixture adjustable arm lower 102 with the sealing anvil upper 104 and sealing anvil lower 106 clamping the preassembled frit surrounding cartridge assembly 61 between them. The induction coil 110 surrounds the preassembled frit surrounding ring cartridge assembly 61 and is powered by induction coil head 112.

FIG. 19 shows a cross-sectional view through the induction coil of FIG. 18, taken at 19-19 of the configuration of the induction coil 110 is powered by the induction coil head 112, wherein considering the possible plastic/polymer surrounding rings as described above the rings 58, 58a, 58a, 58c, 58c1, 58c2 may be located similarly to the fits described above identified as 56, 64, 65, 66, 67, 68, 82, 83, 90, 91, 92 may be located up prior to their processing in a process and method as described herein.

As mentioned earlier, a polymer support ring to frit configuration do not have to be concentric or one inside or outside of the other. As long as the configuration of the polymer is susceptible to being mechanically sealed tightly at high pressures, a surface to surface contact between the polymer and a surface of the frit along with use of the induction heating method described herein will provide a polymer fusion flow into the poor passageways of the frit to depth from the surface of the frit past the first, second, or several frit or passageway necking (or narrowing) locations as the passageway extends into the frit.

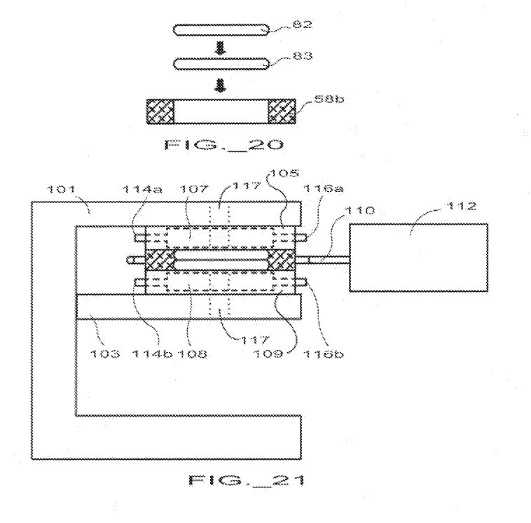

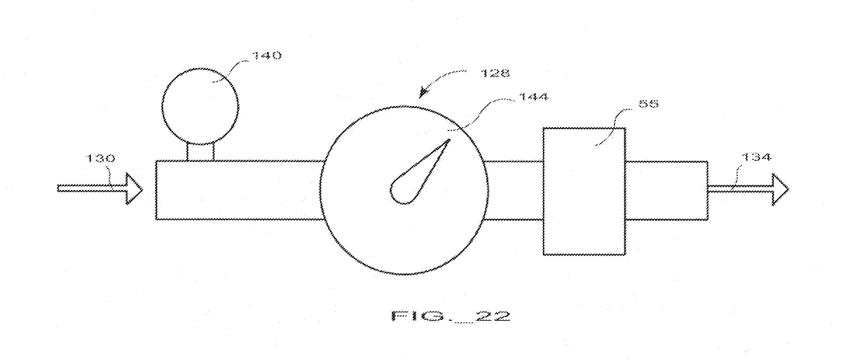

FIG. 20 shows an arrangement of a stack of two frits (82, 83) with chamfered corners in a pre-assembly arrangement for positioning inside a surrounding polymer ring 58b, for example, similar to that of FIG. 4 except that the square cornered frits shown there are replaced with chamfered corner fits 82, 83.

FIG. 21 shows an alternate embodiment of a processing assembly having a sealing fixture base 101 opposite a sealing fixture adjustable arm 103 holding a sealing anvil upper 105 with a cooling channel 107 therein. A cooling fluid inlet line 114a and a cooling fluid outlet line 116a provide conduits for supply and removal of cooling fluid from the cooling channel 107. A lower sealing anvil 109 with a cooling channel 108 therein has a cooling inlet line 114b and a cooling outlet line 116b. These carry cooling liquids to and from the lower ceiling anvil. There are also centralized open holes upper 117 and lower 118 which extend through the sealing fixture base 101 and through the sealing anvil upper 105, and through the sealing fixture adjustable arm 103, and the lower sealing anvil 109, respectively. These centralized open holes 117, 118 provide the air cooling or direct observation of the frit surface for cooling (or heating) fluid such as air through the frit while or after the heating process has been completed.

Alternately, while induction heating as substantially non-directional bulk heating of the bulk frit material in its induced field is ideal, any non-contact heating, or contact heating which heats the center part of the frit surrounding ring cartridge assembly could result in similar mechanical infusion and adhesion as described by the induction heating process. Therefore, the heating of the metal part of the frit could be done by other processes (ideally, those with non-contact substantially directional heating) such as: RF heating, infrared heating, heating using a laser beam through the center holes on each side of the frit to heat the metal of the frit. In the case of a glass frit heating the glass or using heated thermal probes with contact heating where the heated probes would contact the frit (or other material frit) while the polymer ring would remain at a lower ambient temperature and the temperature gradient from ambient to that experienced by the frit in the center of the assembly is created, as a temperature rise in the system occurs substantially directionally as conductive and convective heat energy transfer from the initial point (or points) in contact or exposed to a directional thermal energy source or non-directionally as the bulk material of the frit is heated inductively, generally without heating the surrounding plastic/polymer material. A bulk heating of both the plastic ring and frit (assembly) will result in the plastic running into the frit and dimensional stability of the outside polymer ring will be lost. Therefore a general heating without a temperature gradient will be unsuccessful and will not result in a high-pressure frit with surrounding ring cartridge assembly.

Materials which are contemplated that would seem to work in the described arrangements include: steel and its alloys, stainless steel, aluminum, titanium or any inductively heatable material for the inductive heating. Frits made of glass could be used if they were laser heated or heated by a hot gas passing through the center or heated by a contact probe. The material successfully used for the surrounding plastic ring is a is a thermoplastic polymer Delrin® also known generically as polyoxymethylene. A diverse selection of other plastic ring compositions are possible given that they had thermal properties which permit the melting operation as described above.

Anvil surfaces may be textured although this is not preferred. Preferably the anvil surfaces would be polished and made of borosilicate (glass) or quartz or other glasslike—or a ceramic material such as Zerodur® a lithium aluminosilicate glass-ceramic produced by Schott AG. The surface should be polished to a reflective finish such that any suitable adherence or melting of the polymer tip polymer material on such a polished surface would fully, immediately and easily disengage from the surface as it was cooled without intrusion of the polymer material into the anvil surfaces as might happen if they were forced ceramic surfaces.

Testing of Porous Sintered Materials

Other than standard tests for physical dimensions, most of the qualification tests for controlled porosity of powdered metallurgy parts are application oriented rather than product oriented.

The best test is for the designer to specify the performance, i.e., the device must work satisfactorily. In a typical performance test, sample components preassembled in their housings are tested under simulated performance conditions. Flow rate and pressure drop are measured. Each test stand is periodically rechecked with the standard test parts.

Typical performance test setups are shown as follows: the most frequently used test is as follows, fluid passes through a flow meter, the porous part and then to atmosphere.

FIG. 22 provides a schematic diagram of one frit surrounding polymer ring cartridge assembly testing arrangement. A pressure inlet indicated by pressure indicator 140 is applied by a fluid input flow 130. The atmospheric pressure at the outlet 134 establishes a differential pressure across the frit—polymer ring assembly 55.

Empirical values can be established to determine that the process of polymer ring infusion and adhesion has been successful by utilizing known empirical established values or mechanical clamping.

When several frits are stacked and assembled in a stack, they can be all of one porosity or of multiple porosities. In a three frits stack (unless there is a directional orientation of the usefulness of the three frit stack) the frits on the outside (top and bottom) can be of a larger porosity (of for example 15 μm) while the frit in the center can have a smaller porosity (such as 5 μm) so that the larger particles are isolated by either the top or bottom frit first encountering the contaminated fluid and thus capturing those larger particles. Through this system, the small holes of the smaller porosity frit do not fill up as quickly. Preliminary testing has shown that the life of the liquid chromatography separation columns can be extended by use of the frit polymer ring cartridge assemblies as described herein as the complete elimination of contaminants flowing into the chromatography separation column is eliminated and the probability of blow by and frit polymer ring failure is substantially reduced. In general an increased feed pressure to the liquid chromatography system is contemplated to be in the range of from the current infusion pressure of about 500 to about 1500 PSI (about 3.447e+006 to about 1.034e+007 newtons/square meter) up to 6000 PSI (4.137e+007 newtons/square meter). The frit polymer ring assembly cartridge described herein is able to withstand approximately 18,000 PSI (approximately 1.241e+008 newtons/square meter) pressurized flow, without blow by or other failure. This is three times the expected maximum inlet pressure. Therefore it is unlikely that any failures of the filter cartridge will be due to a breaching of the fit's perimeter edge to polymer ring inner surface interface.

In comparison to prior art fit filters or injection molded (insert molded) filters of the present configuration have a substantially increased adhesion between the frit and the polymer ring surrounding it. When a filter frit and surrounding ring cartridge as described according to the present arrangement, are cut in half, the two pieces will remain with a half ring of the polymer surrounding a half frit. The frit will have to be forcibly cut away or extracted from the surrounding polymer half because it is not held by an interference fit, rather through the infusion of multiple tensile elements created by the infusion of the plastic material in its liquid phase into the pores on the frit which have then solidified to create a series of tensile elements which cannot easily be broken.

Alternately, another test which may be illustrative would be a push test, which would allow the polymer ring surrounding the frit(s) to be held while an axial push out force is exerted just on the center frit(s). In such an arrangement the frit surrounding polymer ring assembly will resist the push out force and achieve a much higher push out force level than frit surrounding polymer ring assemblies created by an interference fit (a press fit), or insert molded as is known in the prior art.

The present arrangement solves a long existing problem which many people have not been able to solve and provides a great leap forward in the pre-filtering of materials being fed to high-pressure inlet would chromatography systems and in fact facilitates the use of future ultrahigh pressure liquid chromatography systems.

While multiple embodiments have been described in the description provided, the description is not intent to limit the scope of possible embodiments as might be understood of a person skilled in the art.

1. A frit filter assembly comprising:
a frit having a first side and a second side opposite said first side and a perimeter side extending around the frit and between the first side and the second side, wherein pore openings in said frit prevent passage of particles larger than a size of said pore openings in said frit as fluid flows through the frit from said first side of the frit to said second side, wherein said frit has a set of perimeter pore openings on its perimeter side;
a frit support ring having a frit facing surface in an interlocking contact with at least one of said first, second, and perimeter sides of said frit, wherein the material of the frit facing surface extends into and at least partially through a narrowing passage of said pore openings at the surface of at least one of said first, second, and perimeter sides of the frit, thereby providing mechanical engagement and adhesion between said frit and said frit support ring.

2. The frit filter assembly as in claim 1, wherein said frit and frit support ring are configured to provide a fluid passage through pores in said frit from one of said at least one of said first, second, and perimeter sides of said frit to a second of said at least one of said first, second, and perimeter sides of said frit, said fluid passage continuing through an opening in said frit support ring.

3. The frit filter assembly as in claim 1,
wherein the frit support ring has a frit facing surface surrounding and in an interlocking contact with said perimeter side of said frit, wherein the material of the material of the frit support ring at said frit facing surface has migrated into and at least partially through said perimeter pore openings in the perimeter side of the frit providing mechanical engagement and adhesion between said frit and said frit support ring.

4. The frit filter assembly as in claim 3,
wherein the material of the frit facing surface has migrated into and at least partially through said perimeter pore openings all around the perimeter side of the frit and to a predetermined infusion depth, and
wherein the mechanical engagement and adhesion between said frit and said frit support ring is characterized by preventing the passing of fluid from said first side to said second side between said perimeter side of said frit and said frit facing surface of said frit support ring.

5. The frit filter assembly as in claim 4,
wherein said mechanical engagement and adhesion includes migration of the frit support ring from the frit facing surface into and through said perimeter pore opening to a distance equaling two or more frit pore sizes from said perimeter side of said frit.

6. The frit filter assembly as in claim 1,
wherein the frit is made from one of the materials chosen from the list comprising: steel and its alloys, stainless steel, aluminum, titanium, any inductively heatable material, and glass.

7. The frit filter assembly as in claim 3,
wherein two or more frits are stacked one on top of the other and all perimeter sides of said two of more frits are contained within and facing said frit facing surface of said frit support ring.

8. The frit filter assembly as in claim 1,
wherein said frit support ring is made of a polymer.

9. The frit filter assembly as in claim 8,
wherein said polymer is a thermoplastic polymer.

10. The frit filter assembly as in claim 9,
wherein said polymer is polyoxymethylene.

11. The frit filter assembly as in claim 2,
wherein said frit support ring is made of a thermoplastic polymer.

12. The frit filter assembly as in claim 3,
wherein said frit support ring is made of a thermoplastic polymer.

13. The frit filter assembly as in claim 3,
wherein said mechanical engagement and adhesion includes extension of the material of the frit support ring from the frit facing surface into and through said perimeter pore opening to a distance beyond two or more frit pore necks from a frit surface in at least two pore passages in each of four separate regions equally distributed around said frit.

14. A method of making a frit assembly comprising the steps of:
placing a frit surface of a frit having a selected filtering porosity in contact with a surface of a polymer frit support ring;
heating the frit for a predetermined time causing infusion of the polymer material of the polymer support ring into the pore openings at the surface of the frit in contact with the ring and through at least one pore neck of the pore passages extending from the pore openings at the surface of the frit.

15. The method of making a frit assembly as in claim 14,
wherein the step of heating the frit is done by induction heating.

16. The method of making a frit assembly as in claim 15,
wherein the induction heating is done by using a wire having a loop shape located near the frit, the loop having a central axis approximately centered on said frits being heated and in close proximity thereto.

17. A method of making a frit assembly as in claim 14,
wherein the step of placing a frit surface includes placing a frit within a surrounding polymer ring, such that a perimeter outer surface of the frit is in contact with an inner perimeter surface of said polymer ring.

18. The method of making a frit assembly as in claim 17,
wherein the step of heating the frit is done by induction heating.

19. The method of making a frit assembly as in claim 18,
wherein said frit, may include two or more fits positioned adjacent one another, wherein the induction heating is done by using a wire having a loop shape located near the frit, the loop having a central axis approximately centered on said one or more fits being heated and in close proximity thereto.

20. The method of making a frit assembly as in claim 18,
wherein the induction heating is performed by energizing said wire having a loop shape with a 600 to 2 MHz frequency for approximately 8 seconds at approximately 2000 watts.

21. The method of making a frit assembly as in claim 17,
wherein the step of heating the frit is done by one or more heating processes selected from the heating processes comprising, RF heating, infrared heating, heating from both ends using at least one laser light heating source, and heating from both ends using at least one contact heating source.

22. The method of making a frit assembly as in claim 17,
wherein a lower anvil supports the frit and the surrounding polymer ring and an upper anvil covers the frit and the surrounding polymer ring during heating.

23. The method of making a frit assembly as in claim 17,
wherein the step of heating the frit for a predetermined time is a time sufficient to raise the temperature of the frit surface in contact with the frit support ring surface to melt the frit support ring material to cause it to infuse into and through a pore neck in the pore passageway extending from the pore openings in said frit surface, but is not a time so long that the melting the of frit support ring material and its infusion into pores in the surface of said frit material causes the frit support ring material to deform and thereby distort a sealing surface of the frit support ring against which fluid sealing to a pressure exceeding a frit filter assembly inlet pressure when connected to an inlet fluid flow source is required in use.

24. The method of making a frit assembly as in claim 23,
wherein said frit filter assembly inlet pressure exceeds 1500 psi.

25. The method of making a frit assembly as in claim 24,
wherein said frit filter assembly inlet pressure exceeds 5000 psi.

26. The method of making a frit assembly as in claim 25,
wherein said frit filter assembly inlet pressure exceeds 10000 psi.

27. The method of making a frit assembly as in claim 26,
wherein said frit filter assembly inlet pressure exceeds 18000 psi.
